(19) United States
(12) Patent Application Publication
(10) Pub. No.: US 2014/0372541 A1
(43) Pub. Date: Dec. 18, 2014

(54) SYSTEM AND METHOD FOR ACTION-BASED INPUT TEXT MESSAGING COMMUNICATION

(71) Applicant: John C. Feghali, Pittsburgh, PA (US)

(72) Inventor: John C. Feghali, Pittsburgh, PA (US)

(21) Appl. No.: 14/301,951

(22) Filed: Jun. 11, 2014

Related U.S. Application Data
(60) Provisional application No. 61/834,208, filed on Jun. 12, 2013.

(51) Int. Cl. H04L 12/58

(52) U.S. Cl. CPC H04L 51/04
USPC 709/206

(57) ABSTRACT

Systems and methods are described herein that allow computing device users to send and receive encapsulated messages through text messaging. Message encapsulation formats are defined that mimic real-world scenarios. Sensors on a computing device, such as a smartphone, may be used to simulate an action that triggers an encapsulated message to be transmitted or retrieved.

### CROSS REFERENCE TO PRIOR APPLICATIONS

This application claims priority under 35 U.S.C. §119(e) to U.S. Provisional Patent Application No. 61/834,208, filed Jun. 12, 2013, titled “Action Based Input Using Smartphone, Tablet, or Computer Sensors to Encapsulate and Read or Listen to a Text/Instant Message/Voice/Picture or Video Message,” the disclosure of which is hereby expressly incorporated herein by reference in its entirety.

### BACKGROUND

The present disclosure relates generally to text messaging communications, and more particularly to associating actions with sending or receiving messages in a text messaging communication session.

Text messaging includes the exchange of brief written messages over a network between phones and/or computing devices. Mobile instant messaging (MIM) technology extends text messaging service accessibility to mobile computing platforms (e.g., standard mobile phones, smartphones, and electronic tablets). With MIM technology, instant messaging services can be accessed from computing devices, including standard mobile phones and smartphones using a myriad of operating systems.

In text messaging, whether fixed-line or mobile, real-time text messages are communicated directly between individuals using computing devices (e.g., personal computers or mobile phones). Two types of text messaging are instant messaging and online chat. Although qualitatively similar, instant messaging is used in common parlance to refer to communications between known users (e.g., using a contact list or a friend list) whereas online chat is used to refer to communications among anonymous users in a multi-user environment.

An inherent limitation of text messages is that each message is often limited to 160 bytes of data (although some providers reserve some of those bytes for service use), or approximately 160 alphanumeric characters of the English alphabet. This size limitation severely restricts the type of data that can be transmitted via text message. As a result, graphical expression in text messages has been limited to one or more textual emoticons composed of alphanumeric symbols (e.g., a colon and a right parenthesis to symbolize a happy face, or a smiley face included within a font set), an attached graphic image file (e.g., a .GIF file of a winking smiley face or a flash animation of kissing lips), or a simple descriptive statement of an imaginary graphic action (“John has thrown a cow at you.”). Because these graphical options are limited, the ability to encapsulate a message within such an expression and to associate user action with sending or receiving a message does not exist in prior art text messaging systems.

### SUMMARY OF THE DISCLOSURE

According to one aspect of the disclosure, a method is described herein for sending an encapsulated message during a text messaging session comprising receiving, at a first computing device, a selection of a message encapsulation format for sending the encapsulated message to a second computing device; receiving, at the first computing device, an input of a message to be encapsulated to generate the encapsulated message; and triggering transmission of the encapsulated message from the first computing device to the second computing device.

According to another aspect of the disclosure, a method for receiving an encapsulated message in a text messaging communication session comprises receiving, at a second computing device, an encapsulated message transmitted from a first computing device, wherein content of the encapsulated message is not initially visible; determining an action required to view the content of the encapsulated message; determining that the action has been performed; and displaying the content of the encapsulated message.

Additional features, advantages, and embodiments of the invention may be set forth or apparent from consideration of the following attached detailed description and drawings. Moreover, it is to be understood that both the foregoing summary of the invention and the following attached detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced.

FIG. 1 is a block diagram illustrating one aspect of a system for sending and receiving encapsulated messages during a text messaging communication.

FIG. 2 is a block diagram illustrating an example of a computing device for sending or receiving encapsulated messages in a text messaging communication.

FIG. 3 illustrates aspects of an encapsulated messaging component.

FIG. 4 is a flow chart depicting a method for sending an encapsulated message during a text messaging communication session.

FIG. 5 is a flow chart depicting a method for receiving an encapsulated message during a text messaging communication session.

FIG. 6 depicts a layered architecture of text messaging system according to some aspects of the disclosure.

FIGS. 7-10 illustrate examples of text message encapsulation formats.

FIGS. 11-13 illustrate examples of a user interface for sending an encapsulated message.

FIG. 14 illustrates and example of a user interface for receiving an encapsulated message.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following attached description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the ivention. Accordingly, the examples and embodiments herein should not be construed as limiting the scope of the invention, which is defined solely by the appended claims and applicable law. Moreover, it is noted that like reference numerals represent similar parts throughout the several views of the drawings.

Systems, methods, and apparatus are described herein for sending and receiving encapsulated messages through text messaging. A plurality of message encapsulation formats may be provided that mimic real-world scenarios. Sensors on a computing device, such as a smartphone, may be used to send and/or retrieve an encapsulated message. For example, a selected message encapsulation format may require an action to be performed using a sensor to send and/or retrieve an encapsulated message. The systems, methods, and apparatus described herein provide context to a message through visual effects.

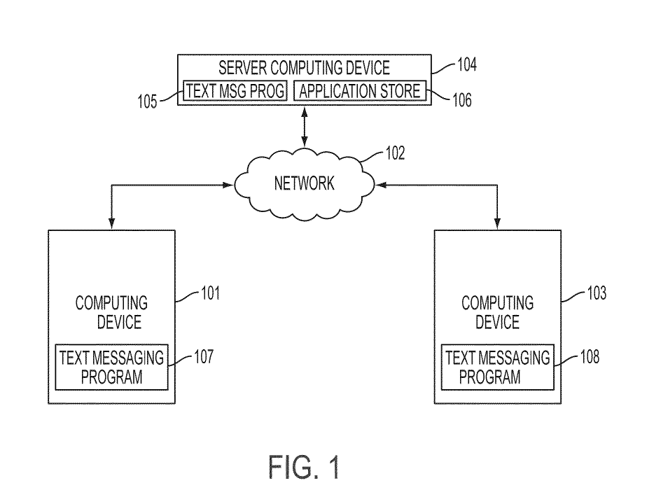

FIG. 1 is a block diagram of one aspect of the system described herein for sending and receiving encapsulated messages during text messaging communications. Computing device 101 may be coupled through network 102 to communicate over a communication link with computing device 103 during the text messaging communication (e.g., instant messaging or online chat) session governed by a text messaging protocol. Both computing device 101 and computing device 103 may also be connected through network 102 to a server computing device 104 (e.g. a server) to obtain a copy of text messaging program 105. Text messaging program 105 may include a plurality of message encapsulation formats. Additional message encapsulation formats may be retrieved from an application store 106. For example, additional message encapsulation formats may be purchased by computing device 101 or computing device 103 by connecting to the application store 106. Once obtained, a copy of text message program 105 may be stored locally on each of computing device 101 and computing device 103. Computing device 101 may store text messaging program local copy 107 while computing device 103 stores text messaging program local copy 108. While only two computing devices are shown in FIG. 1, the systems and methods described herein are not limited to one-to-one communication. A plurality of computing devices may communicate amongst each other via both one-to-one and group communication means.

One of skill in the art will recognize that computing device 101 and computing device 103 can be identical devices or different types of devices. Computing device 101 and computing device 103 are preferably smartphones, such as an iPhone from Apple, Inc., a BlackBerry, from Research in Motion Limited, or a phone running the Android OS from Google, Inc. of Mountain View, Calif. Ho each computing device may be a home personal computer (PC), a corporate PC, a laptop, a netbook, or any network-enabled computing device. Examples of network-enable computing devices include a cellular phone, personal digital assistant (PDA), media device (such as an iPod from Apple, Inc), an electronic tablet (such as an iPad from Apple, Inc.) or an electronic reader devices (such as the Kindle from Amazon.com, Inc. of Seattle, Wash.).

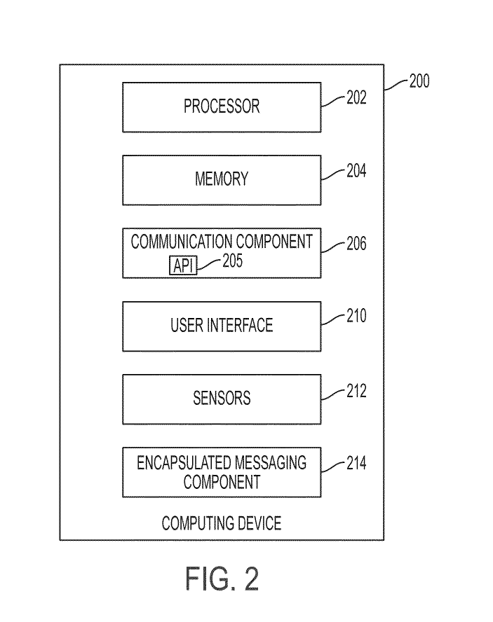

FIG. 2 is an example of a computing device 200 that may be used to implement aspects of the disclosure. For example, computing device 101 and/or computing device 103, shown in FIG. 1, may be configured as shown by computing device 200. Computing device 200 may include a processor 202 for carrying out processing functions associated with one or more of components and functions described herein. Processor 202 can include a single or multiple set of processors or multi-core processors. Moreover, processor 202 can be implemented as an integrated processing system and/or a distributed processing system.

Computing device 200 further includes a memory 204, such as for storing data and/or local versions of applications being executed by processor 202. Memory 204 can include any type of memory usable by a computer, such as random access memory (RAM), read only memory (ROM), tapes, magnetic discs, optical discs, volatile memory, non-volatile memory, databases, and any combination thereof.

Further, computing device 200 may include a communications component 206 that provides a means for establishing and maintaining communications over one or more communication links with one or more parties utilizing hardware, software, and services as described herein. Communications component 206 may carry communications between components on computing device 200, as well as between the computing device 200 and external devices, such as devices located across a network and/or devices serially or locally connected to computing device 200. For example, communications component 206 may include one or more buses, and may further include transmit chain components and receive chain components associated with a transmitter and receiver, respectively, operable for interfacing with external devices. In accordance with some aspects of the disclosure, communications component 206 may include one or more application programming interfaces (APIs) 205 for accessing processor 202 and/or the data from one or more sensors 212.

Computing device 200 may additionally include a user interface component 210 operable to receive inputs from a user of computing device 200, which may be further operable to generate outputs for presentation to the user. User interface component 2110 may include one or more input devices, including but not limited to a keyboard, a number pad, a mouse, a touch-sensitive display, a navigation key, a function key, a microphone, a voice recognition component, a still camera, a video camera, an audio recorder, and/or any other mechanism capable of receiving an input, or any combination thereof. Further, user interface component 210 may include one or more output devices, including but not limited to a display, a speaker, a haptic feedback mechanism, a video projector, a printer, any other mechanism capable of presenting an output, or any combination thereof.

Computing device 200 may include a plurality of sensors 212. For example, sensors 212 may include touch screens, microphones, cameras, accelerometers, light sensors, proximity sensors, gyroscopes, biometric readers, temperature gauges, compasses, and/or other sensors. The sensors 212 may be configured to collect data indicating an action performed by a user of the computing device. According to aspects of the disclosure, the data may be used to determine whether an action required by the sender or recipient of a message, based on a chosen message encapsulation format, has been performed. Computing device 200 may also include encapsulated messaging component 214 configured to allow a user to send and receive encapsulated messages during a text messaging communication.

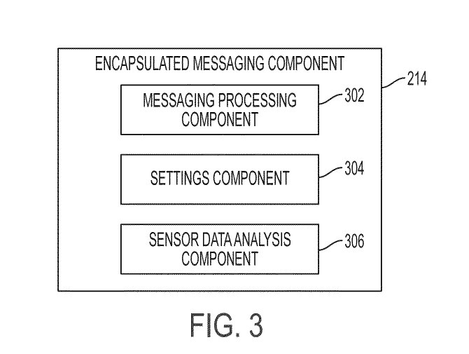

FIG. 3 illustrates encapsulated messaging component 214 in greater detail. Encapsulated messaging component 214 may include a message processing component 302 configured to facilitate sending or retrieving a message. Each message encapsulation format may be configured to visually represent a real-life scenario. For example, a text, picture, or video message may be encapsulated into a visual representation of a scratch card, where a user has to simulate scratching the card to view the encapsulated message. Each stored format may be associated with one or more actions, which may be in turn associated with one or more sensors. Following the scratch card example, the action associated with this message format may be “scratching” the card, while the sensor for detecting the action may be a touch screen. Each message format may require actions to be performed by the sender to send a message or by the receiver to receive a message. Message processing component 302 may be configured to present message encapsulation format options to a user, receive a user selection of an option, receive user input of the message to be encapsulated, and generate the encapsulated message.

A settings component 304 may be provided for customizing how messages are sent and received. For example, settings component 304 may enable a user to set a time limit or expiration point indicating how long a message is displayed or stored after being viewed. In some aspects, settings component 304 may be configured to enable a user to turn off any requirements to perform an action to retrieve a message.

Sensor data analysis component 306 may be configured to process sensor data to determine whether required actions have been performed. The sensor data analysis component 306 may be configured to collect data from the sensors and compare the received data to the requirements associated with a selected message encapsulation format to determine whether a message should be sent or retrieved.

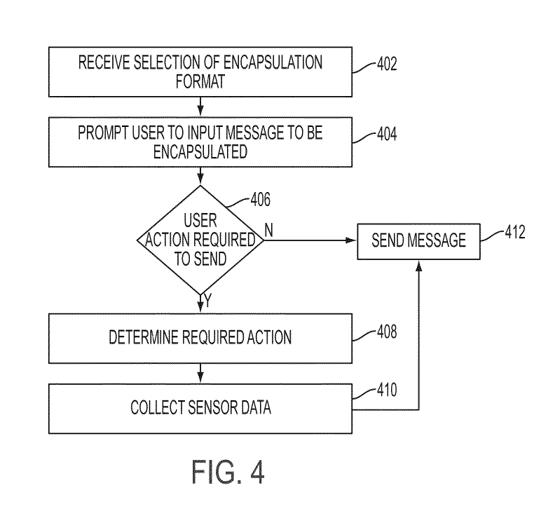

FIG. 4 is a flowchart illustrating an example of a method for sending an encapsulated message during a text communication session. As shown at 402, the computing device may receive a user selection of a message encapsulation format. As shown at 404, the computing device may then prompt a user to input the message to be encapsulated. As described herein, the message may include any combination of text, audio, video, or graphics/pictures. As shown at 406, the computing device may determine whether the selected message encapsulation format requires the user to perform an action to trigger sending of the message. For example, the message encapsulation format may be a format mimicking a sender blowing a bubble to the receiver. In this example, the sender action may require the sender to blow into the microphone to represent blowing bubbles. Thus, the action associated with the message may be blowing a bubble and the sensor for detecting the action may be the microphone.

If no action is required of the sender, the message may be sent to the recipient, as shown at 412. If one or more actions are required, the computing device first determines which action is required, as shown at 408. This may include, for example, determining which sensor is associated with the required action. As shown at 410, data from the associated sensors are collected to determine that the required action has been performed. Data from the sensors may include, for example, a representation of device movement, sound generated by the sender, voice recognition data, light intensity, proximity to the device, location of the device, orientation of the device, etc. Once the required actions have been performed, the message may be transmitted to the recipient, as shown at 412.

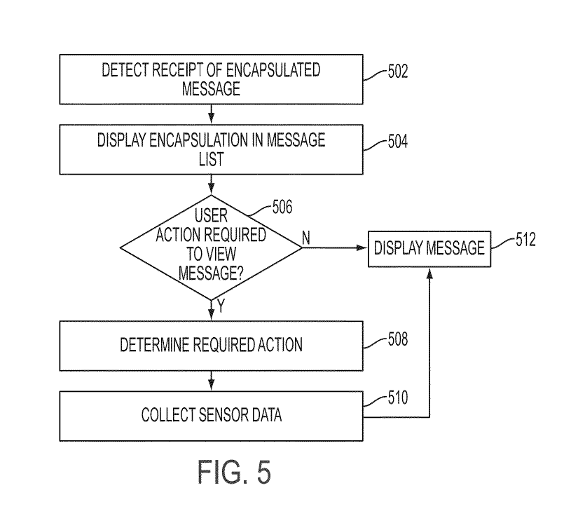

FIG. 5 illustrates a process for receiving an encapsulated message. As shown at 502, a computing device may detect receipt of an encapsulated message. The encapsulated message may be displayed in a graphical user display provided by the text message application, as shown at 504. For example, where the message has been encapsulated in bubbles, an image of bubbles may be shown in the text message display. The displayed image may also include instructions for retrieving the message. For example, along with the image of the bubbles, instructions to pop the bubbles may also be shown. The instructions may be textual or graphical.

As shown at 506, the computing device determines whether an action required to retrieve the encapsulated message has been performed. In the bubble example, the action required of the user may be to pop the bubbles, and this action may be associated with tapping the touch screen. If no action is required, the message can be displayed, as shown at 512. If an action is required, the computing device determines the required action, as shown at 508, and collects sensor data to determine that the action has been performed, as shown at 510. The messages may then be displayed, as shown at 512. The retrieved message may be listed in the recipient's message stream with an indication of the encapsulation format originally used to transmit the message. For example, in the bubbles example, the bubbles may be displayed next to the retrieved message.

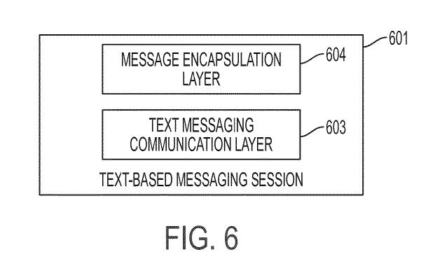

The messaging system described herein may consist of two layers, as illustrated in FIG. 6. During a text messaging session 601, messages may be conveyed between a sending computing device and one or more receiving computing devices in a text messaging communication layer 603 using known messaging communication protocols. For example, the messaging communication protocol may be the short message service (SMS) protocol or any other messaging communication protocol.

The message to be delivered may be encapsulated using a message encapsulation format in the message encapsulation layer 604. Messages may be encapsulated. For example, the message to be transmitted may be embedded in a graphical image that may require the recipient to perform an action prior to viewing the message. The message encapsulation layer 604 may be configured to provide metadata specifying the message encapsulation format in use. Additionally, any data collected representing the action performed may form part of the messaging layer.

Examples of types of encapsulated messages will now be described. These are merely examples of the types of message encapsulation formats that may be provided. Any other format may also be used.

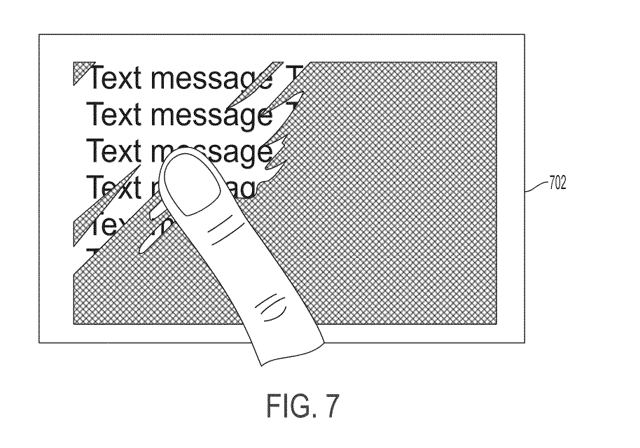

FIG. 7 illustrates an example of a text message being encapsulated in a scratch card format 702. A receiver of such a message may receive a notification that a message has been sent that requires scratching to be read. The receiver may swipe a finger on top of the area of the screen that may look like, e.g., a scratch card to be able to read the message. In this example, the scratch card format requires an action to be performed that is detected by a touch screen sensor.

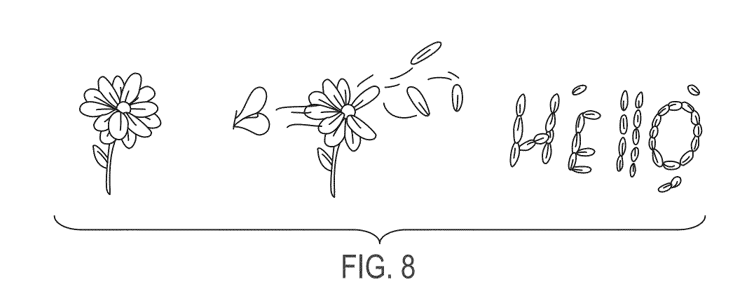

FIG. 8 is another example of an encapsulation format. Here, a message has been encapsulated in a flower. To receive the message, the recipient may be required to blow into the microphone to retrieve the message. As the microphone senses the recipient blowing into the microphone, the display may illustrate lips blowing the petals from the flower to reveal the message.

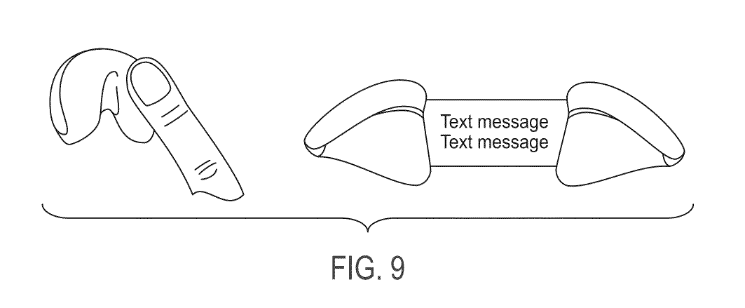

As another example, FIG. 9 illustrates a message encapsulated into a fortune cookie. To read the message inside, the recipient must simulate cracking the fortune cookie. As shown in FIG. 9, this may include tapping the image of the fortune cooking with a finger to reveal the message.

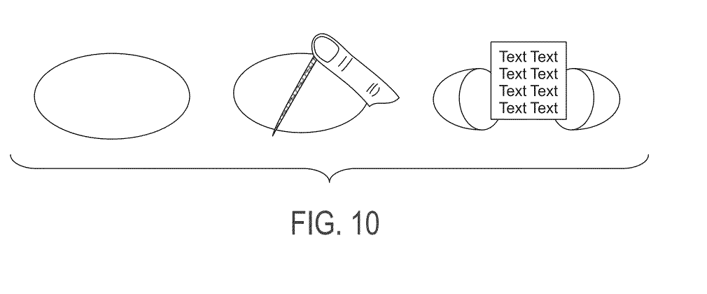

FIG. 10 illustrates a message transmitted as a watermelon. To receive the message, the recipient may be required to “chop” the fruit.

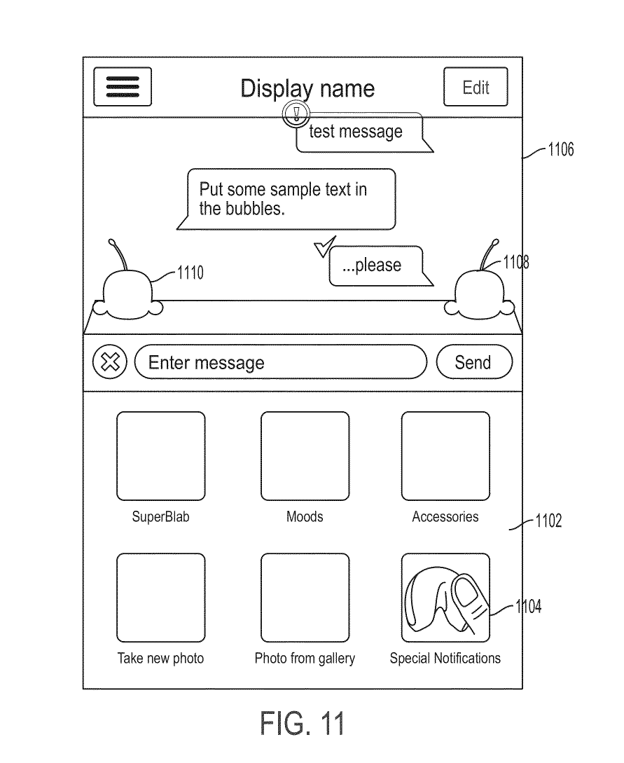

FIGS. 11-14 are examples of text messaging application displays. These are merely examples of one type of display, and the systems, methods, and apparatus described herein are not limited to these examples. Actual display components may vary, for example, based on the type of computing device, text messaging application version, etc.

FIG. 11 illustrates a display that may be present when a user is preparing to send a message. A menu 1102 may be presented enabling the sender to select a message encapsulation type. A special notification option 1104 may be provided, and upon selection of this option, the sender may be presented with a plurality of stored message formats to choose from. A message display area 1106 shows messages previously exchanged between the sender, represented by avatar 1108, and a recipient, represented by avatar 1110.

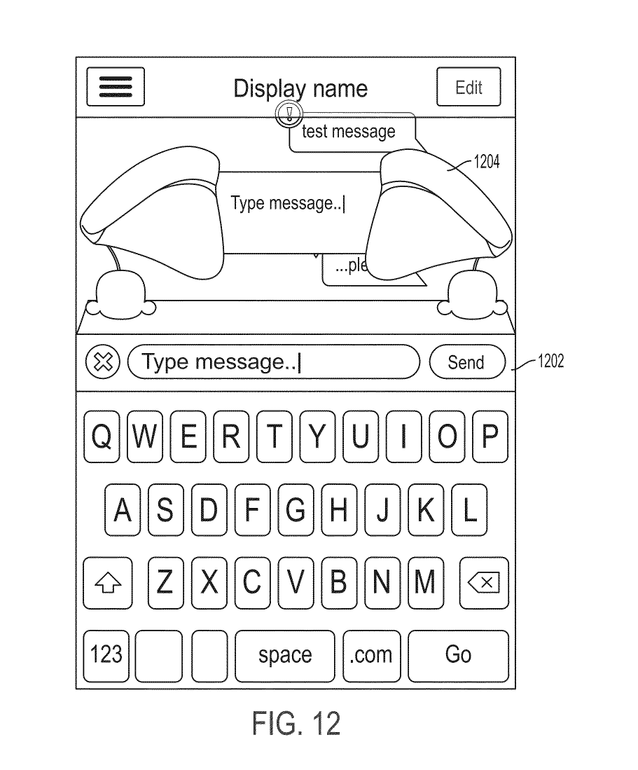

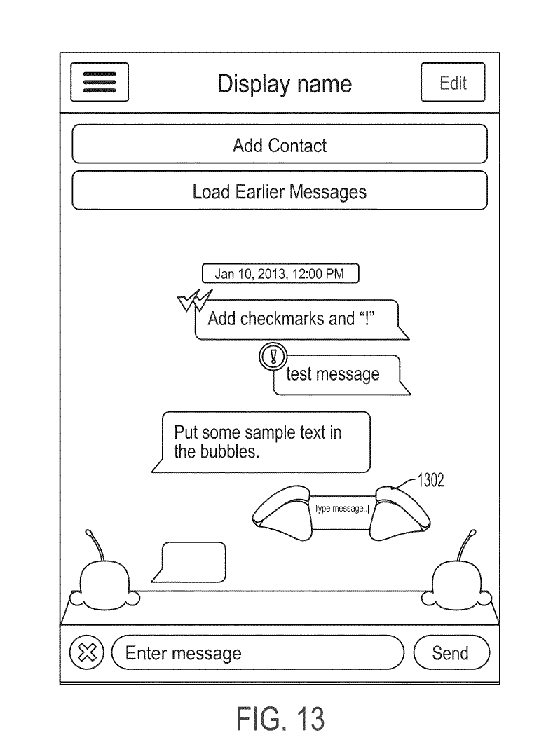

As shown in FIG. 12, once a message encapsulation format has been selected, the sender may be prompted to enter to message to be encapsulated, as shown at 1202. In this example, the sender has chosen a fortune cookie encapsulation type, as shown at 1204. FIG. 13 illustrates the sender's message stream after sending the encapsulated message. As shown at 1302, the message is visible to the sender.

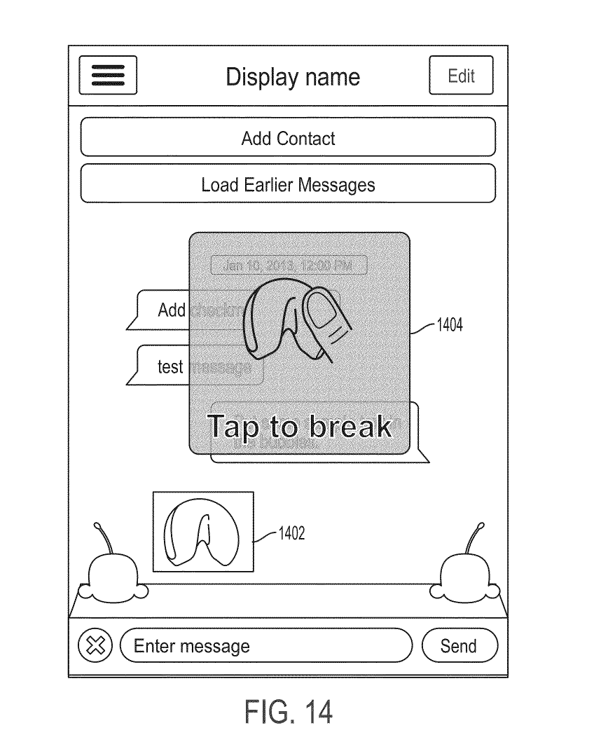

FIG. 14 illustrates an example of a recipient's display. As shown at 1402, the recipient's message stream shows that a fortune cookie has been received. Instructions 1404 for retrieving the message within the fortune cookie are displayed as an overlay. The instructions 1404 may be presented at the time the message is received and/or when the user selects the message. While not shown, after the recipient has retrieved the message, an indication that the message was sent as a fortune cookie may be provided in the message stream. For example, the indication may be an open fortune cookie with the message now visible.

While various examples have been described herein, it is to be understood that such examples are given for illustrative purposes only and can be extended to other implementations and embodiments with different sets of sensors, defined types of motions, conventions, and techniques. While a number of embodiments are described herein, there is no intent to limit the disclosure to the embodiments disclosed herein. In the contrary, the intent is to cover all alternatives, modification, and equivalents apparent to those familiar with the art.

Further, while a number of examples are described as an application running on a computing device, it is to be understood that the application itself, along with the ancillary functions such as sensor operation, device communications, user input, and device display generation, etc., can all be implemented in software stored in a computer readable storage medium for access as needed to run such software on the appropriate processing hardware of the computing device.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a smart phone, a cellular telephone, a tablet, a web-book, a notebook computer, a desktop computer, a workstation computer, a server, a cloud, or the like, or an array of processors, microprocessors, central processing units, general purpose computers, super computers, personal computers, laptop computers, palmtop computers, notebook computers, desktop computers, workstation computers, servers, or the like.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means any combination of software and/or hardware, including any machine, device, circuit, component, or module, or any system of machines, devices, circuits, components, modules, or the like, which are capable of transporting signals from one location to another location, where the signals may comprise information, instructions, data, and the like. A network may include, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), or the like, any of which may be configured to communicate data via a wireless and/or a wired communication medium.

A “server” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “communication link,” as used in this disclosure, means a wired and/or wireless medium that conveys data or information between at least two points. The wired or wireless medium may include, for example, a metallic conductor link, a radio frequency (RE) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like. One or more communication links may be used in an environment 100 (shown in FIG. 1) to allow sufficient data throughput and interaction between end-users (such as, e.g., agents, consumers, insurance carriers, estate planners, financial providers, web host providers, and the like). Techniques for implementing such communications links are known to those of ordinary skilled in the art.

The terms “including,” “comprising,” “having,” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A method for sending an encapsulated message during a text messaging session, comprising:
receiving, at a first computing device, a selection of a message encapsulation format for sending the encapsulated message to a second computing device;
receiving, at the first computing device, an input of a message to be encapsulated to generate the encapsulated message; and
triggering transmission of the encapsulated message from the first computing device to the second computing device.

2. The method of claim 1, wherein said triggering transmission of the encapsulated message comprises:
determining, based on the selected message encapsulation format, whether an action is required to transmit the encapsulated message; and
upon determining that an action is required:
determining at least one sensor associated with the action; and
collecting data from the sensor indicating the action has been performed.

3. The method of claim 2, wherein the at least one sensor comprises a touch screen, a light sensor, an accelerometer, a proximity sensor, a gyroscope, a camera, a compass, a temperature sensor, a fingerprint sensor or a microphone.

4. The method of claim 1, wherein the message to be encapsulated comprises one or more of a text message, a picture message, and a video message.

5. The method of claim 1, wherein the message encapsulation format visually encapsulates the message to be encapsulated.

6. The method of claim 1, wherein the message encapsulation format includes an indicator of one or more actions required to be performed at the first computing device to transmit the message to be encapsulated, or one or more actions required to be performed at the second computing device to receive the encapsulated message.

7. The method of claim 1, wherein the message encapsulation format mimics a real world activity.

8. A method for receiving an encapsulated message in a text message communication session, comprising:
receiving, at a second computing device, an encapsulated message transmitted from a first computing device, wherein content of the encapsulated message is not initially visible;
determining an action required to view the content of the encapsulated message;
determining that the action has been performed; and
displaying the content of the encapsulated message.

9. The method of claim 8, wherein determining the action required to view the content of the encapsulated message comprises:
determining a message encapsulation format associated with the encapsulated message; and
reading metadata associated with the message encapsulation format indicating the action to be performed.

10. The method of claim 9, wherein, detecting that the action has been performed, comprises:
receiving data from one or more sensors representing action; and
determining that the action satisfies the action required by the message encapsulation format.

11. The method of claim of claim 10, wherein the one or more sensors comprise a touch screen, a light sensor, an accelerometer, a proximity sensor, a gyroscope, a camera, a compass, a temperature sensor, a fingerprint sensor or a microphone.

12. The method of claim wherein the content of the encapsulated message comprises one or more of a text message, a picture message, and a video message.

13. The method of claim 8, wherein the action comprises mimicking a real world action.

14. The method of claim 8, wherein the content of the encapsulated message has an expiration period, wherein the content of the encapsulated message is deleted upon expiration.
